(19) United States
(12) Patent Application Publication
(10) Pub. No.: US 2007/0101124 A1
(43) Pub. Date: May 3, 2007

(54) Secure provisioning of digital content

(76) Inventor: William M. Pitts, Los Altos, CA (US)

Correspondence Address: DONALD E. SCHREIBER, POST OFFICE BOX 2926, KINGS BEACH, CA, 96143-2926, US

(21) Appl. No.: 11/487,789

(22) Filed: Jul. 17, 2006

Related U.S. Application Data
(60) Provisional application No. 60/699,452, filed on Jul. 15, 2005.

(51) Int. Cl. H04L 9/00

(52) U.S. Cl. 713/155

(57) ABSTRACT

A method for retrieving an encrypted image of an object from a server site (22), caching it at a client site (24), and providing a decrypted image of the object to an authorized requester. When the requester is not authorized to access a decrypted image of the source data object, the encrypted image of the object cached at a client site (24) may be deleted, and/or, an authentication failure message may be sent to the server site, a security monitoring agency, the object's owner, and/or any other designated entity that can be contacted via any network accessible to the site that has detected the authentication failure.

### CLAIM OF PROVISIONAL APPLICATION RIGHTS

This patent application claims the benefit of U.S. Provisional Patent Application No. 60/699,452 filed on Jul. 15, 2005.

### BACKGROUND

1. Technical Field

The present disclosure relates generally to networked digital computers and, more particularly, to controlling access to encrypted objects that are cached at a site in the network which is remote from the encrypted object's server.

2. Background Art

Recently there have been numerous news accounts of highly classified or confidential data that has been compromised with the loss or theft of a computer system. The accounts of such events include the loss of confidential customer data such as banking and credit card information including Social Security numbers. In general, a need to preserve confidentiality of certain information has been recognized for hundreds if not thousands of years. The need for confidentiality has spawned an entire field of scientific investigation called cryptography.

Perhaps the most challenging circumstance for preserving confidentiality occurs when information must be transmitted between two geographically separated locations. Years ago, before the Internet, a comparatively small fraction of the population truly needed confidential communications for their day-to-day affairs. However, with the arrival of the Internet and E-commerce, almost everyone's day-to-day affairs now depends upon confidential electronic communications, in many instances between and/or among third parties.

The ever increasing need for confidential electronic communications has produced a number of different techniques which enable such communications. For example, Simple Authentication and Security Layer (“SASL”) provides a framework and protocol for adding authentication to connection-based digital computer network protocols. SASL allows any network protocol, regardless of its command syntax, to use standard libraries for handling details of authentication. SASL can also be used to negotiate encryption for the rest of the connection.

Another widely adopted secure communication protocol called Secure Sockets Layer (“SSL”) enables encrpyted communications across the Internet using public-key cryptography. During a SSL negotiation, a client and a server agree to use SSL thereby inserting a message processing security layer between the transport protocol; e.g. Hyper-Text Transfer Protocol (“HTTP”), Telnet protocol, File Transport Protocol (“FTP”) and Lightweight Directory Access Protocol (“LDAP”); and a computer's network protocol connection such as TCP/IP. The privately developed SSL was standardized by the Internet Engineering Task Force (“IETF”) under the name Transport Layer Security (“TLS”). Consequently, TLS is also often used to identify newer versions of the SSL protocol. While the SSL/TLS protocol is widely used for transporting encrypted data via the Internet, its client certificates capability is used much less frequently for authentication.

SSL and TLS are cryptographic protocols that provide secure Internet communication of such things as e-mail, E-commerce, internet faxing, Internet gambling, tele-commuting and so forth. Typically, SSL and TLS protocols authenticate only the server computer, i.e. ensure the server computer's identity, while the client computer remains unauthenticated. The SSL and TLS protocols permit communication between a client computer and a server computer in a way designed to prevent eavesdropping, tampering, and message forgery.

SSL and TLS protocols both employ a number of basic phases.

Client and server computer negotiation for selecting specific details of the communication protocol to be employed for each communication session.

Public key encryption-based key exchange and certificate-based authentication.

Symmetric encryption applied to information being exchanged between the client and server computers.

The SSL and TLS protocols exchange records; each record can be optionally compressed, encrypted and packed with a message authentication code (“MAC”). Each record has a content_type field that specifies which upper level protocol is being used. Using these features the SSL and TLS protocols implement various security measures summarized below.

Numbering all the records and using the sequence number in the MACs.

Using a message digest enhanced with a key so only with the key can you check the MAC.

Protection against several known attacks including man-in-the-middle attacks such as those involving a downgrade of the protocol to a previous, less secure, version of the protocol, or to a weaker cipher suite.

The message that ends the handshake, i.e. the “Finished” message, sends a hash of all data exchanged between the client and server computers.

The pseudo random function splits the input data into 2 halves and processes them with different hashing algorithms, i.e. MD5 and SHA, then exclusive ORs (“XORs”) the two hashes together. This techniques protects the protocol's security if either the MD5 and SHA hashing algorithm is found vulnerable.

In addition to secure communication protocols such as SASL, SSL and TLS, there exists proprietary software and service called CyberAngel® which provides security software that:

1. detects unauthorized access of a protected computer;

2. immediately protects all sensitive or confidential information on that computer, as well as locking specified utilities and applications; and

3. attempts to covertly report the intrusion to a security monitoring center to assist in the recovering a stolen device.

The CyberAngel software's authentication offers selectable single factor and two-factor authentication modes, depending on the level of security required. Violating CyberAngel's authentication instantly protects specified information, data, applications and utilities. After protecting the specified information, CyberAngel immediately searches for some type of communication connectivity to alert the CyberAngel security monitoring center that authentication has been violated.

In providing this security, CyberAngel protects confidential data stored on a “Secure Drive,” preventing unauthorized access to files containing information such as company financials, patient or client information, or corporate business plans. If a computer is stolen and/or CyberAngel authentication is violated, the sensitive data and information on the Secure Drive is encrypted and protected as well as rendered invisible to any unauthorized user. After an authentication violation, CyberAngel also prevents unauthorized use of any dial-up networking utility-preventing access to remote network server or online accounts as well as unauthorized data transfer from the computer to a PDA, Pocket-PC, or Smart-Phone.

CyberAngel permits moving files directories, and applications to the Secure Drive. However, CyberAngel product does not provide encryption for electronically transmitted data such as that provided by SASL, SSL and TLS.

CyberAngel has many features that set it apart from other encryption products. CyberAngel focuses on total directory protection, not just certain files or types of data. Features of CyberAngel's file protection are listed below.

Files written to the Disk Cache remain encrypted—all data written to the hard disk is encrypted.

Deleted files are encrypted to the recycling bin—files are not left in the recycling bin in plain text.

Encrypted data copied to the Swap File remains encrypted—data can not be recovered by reading the Microsoft Windows® swap file.

Files are encrypted on the hard drive. Data is never decrypted to the hard drive—data is only decrypted to memory as needed.

Data is not left decrypted if the system crashes while accessing a file.

Files in secured directories can not be altered, copied, moved, or deleted.

Documents are not changed to encrypt data.

U.S. Pat. No. 6,847,968 (“the ''968 patent”) discloses a method for facilitating access by a NDC client site 24, included in a digital computer system network that is referred to by the general reference character 20 in the block diagram of FIG. 1, to a file that is stored in a local file system tree of a Network Distributed Cache (“NDC”) server site 22. The method disclosed in the '968 patent includes establishing a recursive succession of hierarchical Distributed Data Service (“DDS”) domain trees within one or a combination of digital computer system networks 20 such as the network of NDC sites 24, 26B, 26A and 22 illustrated in FIG. 1. Another aspect of the method disclosed in the '968 patent permits a domain manager located at any NDC site 24, 26B, 26A or 22 to enforce file access policies established by the NDC server site 22. The '968 patent together with published United States Patent Application No. 2005/0091248 A1 (“the '248 patent application”) are hereby incorporated by reference as though fully set forth here.

DDS provides a distributed file system that integrates industry standard file servers (Unix, Linux, Windows, Mac, etc.) into highly distributed, multi-protocol virtual file servers of vast proportions. In this way DDS constructs virtual file servers from heterogeneous collections of industry standard file servers. A single DDS virtual file server provides a highly distributed file service, perhaps, incorporating as many as thousands of geographically dispersed file servers. A single DDS virtual file server may encompass hundreds of petabytes of stored data. Fundamental concepts underlying a DDS virtual file server are disclosed in U.S. Pat. Nos. 5,611,049, 5,892,914, 6,026,452, 6,026,452, 6,205,475, 6,366,952 B2, 6,505,241 B2 and 6,804,706 B2. All of the immediately preceding United States patents are hereby incorporated by reference as though fully set forth here.

DDS global file systems accessible via a DDS virtual file server and its DDS domain trees contain entities that might not normally be thought of as files. Consequently, when describing DDS global file systems the term object is often used to denote a superset class which includes what is conventionally identified as a file.

Object related definitions are:

Object—A named entity represented within a namespace to which a connection can be established for the purpose of reading or writing data. The most common type of object is a file or dataset, but other types include:
directories, domains, and other containers,
live video feeds,
application programs, and
shared memory.
An object includes the object's data and all related metadata. Usually, the phrase “encrypted object” means that the object's data is encrypted but not any metadata. However, most metadata can be encrypted as specified by policy attributes.

Object system—A provider of objects. For example, a file system (a type of object system) contains a collection of files and it provides a service through which its content may be accessed.

Namespace—A set of names in which all names are unique. All objects within an object system have at least one name, and the complete set of all names for all objects comprises the object system's namespace.

Policy Attributes—Policy data specific to a particular object represented and communicated as the object's extended attributes. DDS defines policy attributes as a new type of extended attributes which differ from the “normal” file attributes that are created automatically when an object is created. “Conventional” file attributes convey information about an object such as: owner id, group id, creation time, last modification time, file size, etc.

Requester—A user, a process, a computer or other entity that requests access to an object.

Described in greater detail, FIG. 1 depicts a multi-processor digital computer system network 20. The digital computer system network 20 includes a server site 22, an NDC client site 24, and a plurality of intermediate NDC sites 26A and 26B. Each of the NDC sites 22, 24, 26A and 26B in the digital computer system network 20 includes a processor and RAM, neither of which are illustrated in FIG. 1. Furthermore, the NDC server site 22 includes a disk drive 32 for storing data that may be accessed by the NDC client site 24. The NDC client site 24 and the intermediate NDC site 26B both include their own respective hard disks 34 and 36. A client workstation 42 communicates with the NDC client site 24 via an Ethernet or other type of Local Area Network (“LAN”) 44 in accordance with a network protocol such as a Server Message Block (“SMB”), Network File System (“NFS®”), HTTP, Netware Core Protocol (“NCP”) , or other network-file-services protocol.

Each of the NDC sites 22, 24, 26A and 26B in the networked digital computer system network 20 includes an NDC 50 depicted in an enlarged illustration adjacent to intermediate NDC site 26A. The NDCs 50 in each of the NDC sites 22, 24, 26A and 26B include a set of computer programs and a data cache located in the RAM of the NDC sites 22, 24, 26A and 26B. The NDCs 50 together with Data Transfer Protocol (“DTP”) messages 52, illustrated in FIG. 1 by the lines joining pairs of NDCs 50, provide a data communication network by which the client workstation 42 may access data on the disk drive 32 via the chain of NDC sites 24, 26B, 26A and 22.

The NDCs 50 operate on a data structure called a “dataset.” Datasets are named sequences of bytes of data that are addressed by:

a server-id that identifies the NDC server site where source data is located, such as NDC server site 22; and

a dataset-id that identifies a particular source data object stored at that site, usually on a hard disk, such as the disk drive 32 of the NDC server site 22.

Topology of an NDC Network

An NDC network, such as that illustrated in FIG. 1 having NDC sites 22, 24, 26A and 26B, includes:

1. all nodes in a network of processors that are configured to participate as NDC sites; and

2. the DTP messages 52 that bind together NDC sites, such as NDC sites 22, 24, 26A and 26B.

Any node in a network of processors that possesses a megabyte or more of surplus RAM may be configured as an NDC site. NDC sites communicate with each other via the DTP messages 52 in a manner that is completely compatible with non-NDC sites.

FIG. 1 depicts a series of NDC sites 22, 24, 26A and 26B linked together by the DTP messages 52 that form a chain connecting the client workstation 42 to the NDC server site 22. The NDC chain may be analogized to an electrical transmission line. The transmission line of the NDC chain is terminated at both ends, i.e., by the NDC server site 22 and by the NDC client site 24. Thus, the NDC server site 22 may be referred to as an NDC server terminator site for the NDC chain, and the NDC client site 24 may be referred to as an NDC client terminator site for the NDC chain. An NDC server terminator site 22 will always be the node in the network of processors that “owns” the source data object. The other end of the NDC chain, the NDC client terminator site 24, is the NDC site that receives requests from the client workstation 42 to access the source data object stored on the disk drive 32 at the NDC server site 22.

Data being written to the source data object stored on the disk drive 32 at the NDC server site 22 by the client workstation 42 flows in a “downstream” direction indicated by a downstream arrow 54. Data being loaded by the client workstation 42 from the source data object stored on the disk drive 32 at the NDC server site 22 is pumped “upstream” through the NDC chain in the direction indicated by an upstream arrow 56 until it reaches the NDC client site 24. When data reaches the NDC client site 24, it together with metadata is reformatted into a reply message in accordance with the appropriate network protocol such as NFS, and sent back to the client workstation 42. NDC sites are frequently referred to as being either upstream or downstream of another NDC site.

As described in the patents identified above, for the networked digital computer system network 20 depicted in FIG. 1, a single request by the client workstation 42 to read the source data object stored on the disk drive 32 is serviced as follows.

1. The request flows across the LAN 44 to the NDC client terminator site 24 which serves as a gateway to the chain of NDC sites 24, 26B, 26A and 22. Within the NDC client terminator site 24, NDC client intercept routines 102, illustrated in greater detail in FIG. 2, inspect the request. If the request is an NFS request and if the request is directed at any NDC sites 24, 26B, 26A or 22 for which the NDC client terminator site 24 is a gateway, then the request is intercepted by the NDC client intercept routines 102.

2. The NDC client intercept routines 102 convert the NFS request into a Data Transfer Protocol (“DTP”) request, and then submits the DTP request to an NDC core 106.

3. The NDC core 106 in the NDC client terminator site 24 receives the DTP request and checks its NDC cache to determine if the requested data is already present there. If all data is present in the NDC cache of the NDC client terminator site 24, the NDC 50 copies pointers to the data into a reply message structure and immediately responds to the calling NDC client intercept routines 102.

4. If all the requested data isn't present in the NDC cache of the NDC client terminator site 24, then the NDC 50 of the NDC client terminator site 24 accesses elsewhere any missing data. If the NDC client terminator site 24 were a server terminator site, then the NDC 50 accesses the file system for the hard disk 34 upon which the data resides.

5. Since the NDC client site 24 is a client terminator site rather than a server terminator site, the NDC 50 must request the data it needs from the next downstream NDC site, i.e., intermediate NDC site 26B in the example depicted in FIG. 1. Under this circumstance, DTP client interface routines 108, illustrated in FIG. 2, are invoked to request from the intermediate NDC site 26B whatever additional data the NDC client terminator site 24 needs to respond to the current request.

6. A DTP server interface routine 104, illustrated in FIG. 2, at the downstream intermediate NDC site 26B receives the DTP request from the NDC 50 of the NDC client terminator site 24 and processes it according to steps 3, 4, and 5 above. The preceding sequence repeats for each of the NDC sites 24, 26B, 26A and 22 in the NDC chain until the request reaches the server terminator, i.e., NDC server site 22 in the example depicted in FIG. 1, or until the request reaches an intermediate NDC site that has cached all the data that is being requested.

7. When the NDC server terminator site 22 receives the request, its NDC 50 accesses the source data object. If the source data object resides on a hard disk, the appropriate file system code (UFS, DOS, etc.) is invoked to retrieve the data from the disk drive 32.

8. When the file system code on the NDC server terminator site 22 returns the data from the disk drive 32, a response chain begins whereby each downstream site successively responds upstream to its client, e.g. NDC server terminator site 22 responds to the request from intermediate NDC site 26A, intermediate NDC site 26A responds to the request from intermediate NDC site 26B, etc.

9. Eventually, the response percolates up through the sites 22, 26A, and 26B to the NDC client terminator site 24.

10. The NDC 50 on the NDC client terminator site 24 returns to the calling NDC client intercept routines 102, which then packages the returned data and metadata into an appropriate network protocol format, such as that for an NFS reply, and sends the data and metadata back to the client workstation 42.

The NDC 50

As depicted in FIG. 2, the NDC 50 includes five major components:

NDC client intercept routines 102;

DTP server interface routine 104;

NDC core 106;

DTP client interface routines 108; and

file system interface routines 112.

Routines included in the NDC core 106 implement the function of the NDC 50. The other routines 102, 104, 108 and 112 supply data to and/or receive data from the NDC core 106. FIG. 2 illustrates that the NDC client intercept routines 102 are needed only at NDCs 50 which may receive requests for data in a protocol other than DTP, e.g., a request in NFS protocol, SMB protocol, or another protocol. The NDC client intercept routines 102 are completely responsible for all conversions necessary to interface a projected dataset image to a request that has been submitted via any of the industry standard protocols supported at the NDC sites 24, 26B, 26A or 22.

The file system interface routines 112 are necessary in the NDC 50 only at NDC file server sites, such as the NDC server terminator site 22. The file system interface routines 112 route data between the disk drives 32A, 32B and 32C illustrated in FIG. 2 and a data conduit provided by the NDCs 50 that extends from the NDC server terminator site 22 to the NDC client terminator site 24.

As described above, the '968 patent discloses establishing a recursive succession of hierarchical DDS domain trees that encompass one or a combination of digital computer system networks 20. Arbitrarily chosen names, assigned to each DDS domain, respectively identify the roots of each hierarchical DDS domain tree. In most respects, each DDS domain and that domain's hierarchical DDS domain tree are synonymous. In this way the hierarchically organized DDS domain trees provide a unified name space for accessing objects stored within the DDS domain trees.

Existing security protocols such as SASL, SSL or TLS or security services such as CyberAngel lack an ability to propagate security policy attributes associated with an object stored at a NDC server site 22 together with an encrypted image of the object itself as it traverses the NDC sites 22, 26A, 26B and 24. Furthermore, security protocols such as SASL, SSL or TLS or security services such as CyberAngel lack an ability for a manager of a domain traversed by the encrypted image of the object to apply that domain's security policy attributes to the object.

### BRIEF SUMMARY

The present disclosure permits security policy attributes associated with an object stored at a NDC server site 22 to propagate together with an encrypted image of the object itself as it traverses NDC sites 22, 26A, 26B and 24.

The present disclosure permits a manager of a domain traversed by the encrypted image of the object to attach that domain's security policy attributes to the object.

Briefly, in a network of digital computers a method is disclosed for controlling access by a requester to a decrypted image of an object. Responsive to a requester's access request an encrypted image of the object is:

a) retrieved from a server site included in the network of digital computers; and

b) stored in a cache of a client site included in the network of digital computers.

The method for controlling access by a requester to a decrypted image of an object includes the steps of:

a) invoking an authentication routine for assessing whether the requester is authorized to access the decrypted image of the object;

b) when the authentication routine determines that the requester is authorized to access the decrypted image of the object, securely providing a decryption key to the client site in the network of digital computers that permits the client site to:
i) decrypt the cached encrypted image of the object thereby obtaining the decrypted image of the object; and
ii) provide the decrypted image of the object to the requester.

These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is a block diagram illustrating a prior art networked, multi-processor digital computer system that includes an NDC server terminator site, an NDC client terminator site, and a plurality of intermediate NDC sites, each NDC site in the networked computer system operating to permit the NDC client terminator site to access data stored at the NDC server terminator site;

FIG. 2 is a block diagram illustrating a structure of the prior art NDC included in each NDC site of FIG. 1 including the NDC's buffers; and

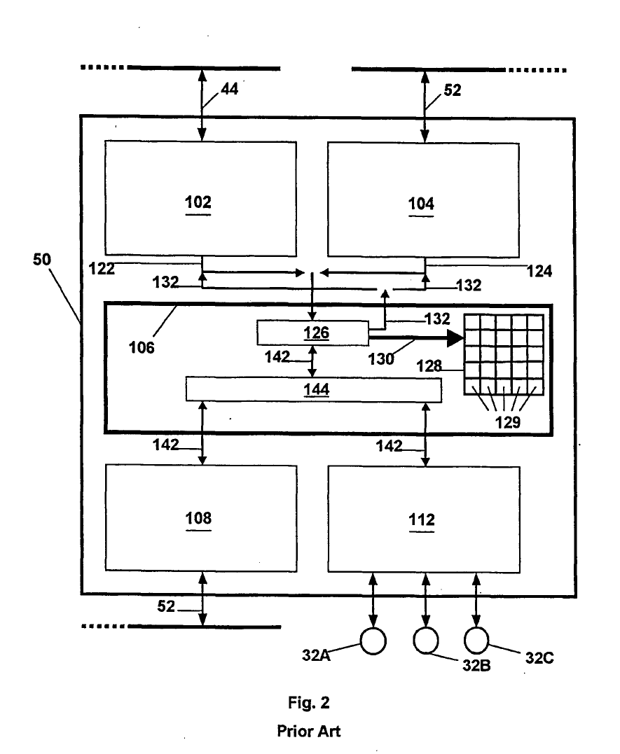

FIG. 3 is a overall flow chart depicting retrieving an encrypted image of an object from a server site, its caching at a client site, and providing a decrypted image of the object to an authorized requester.

### DETAILED DESCRIPTION

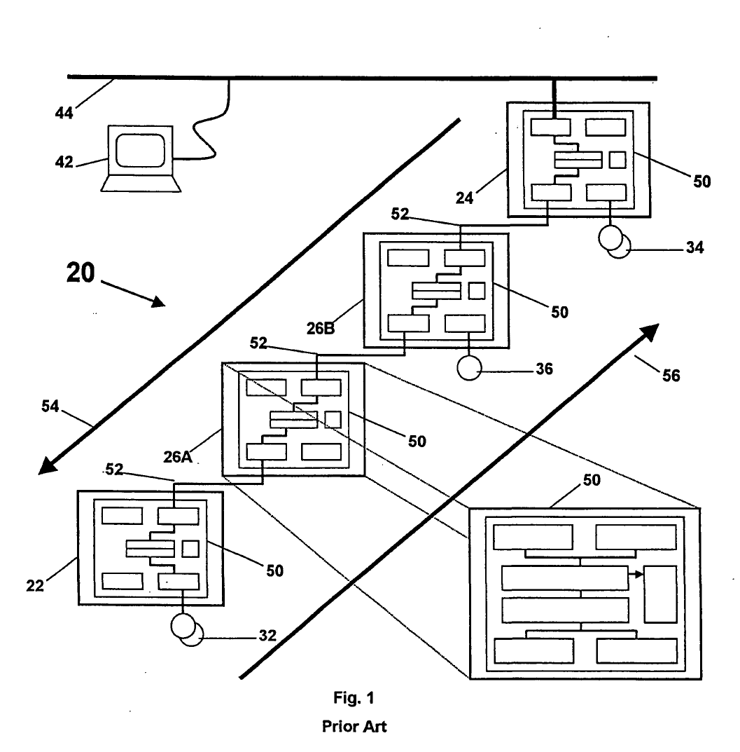

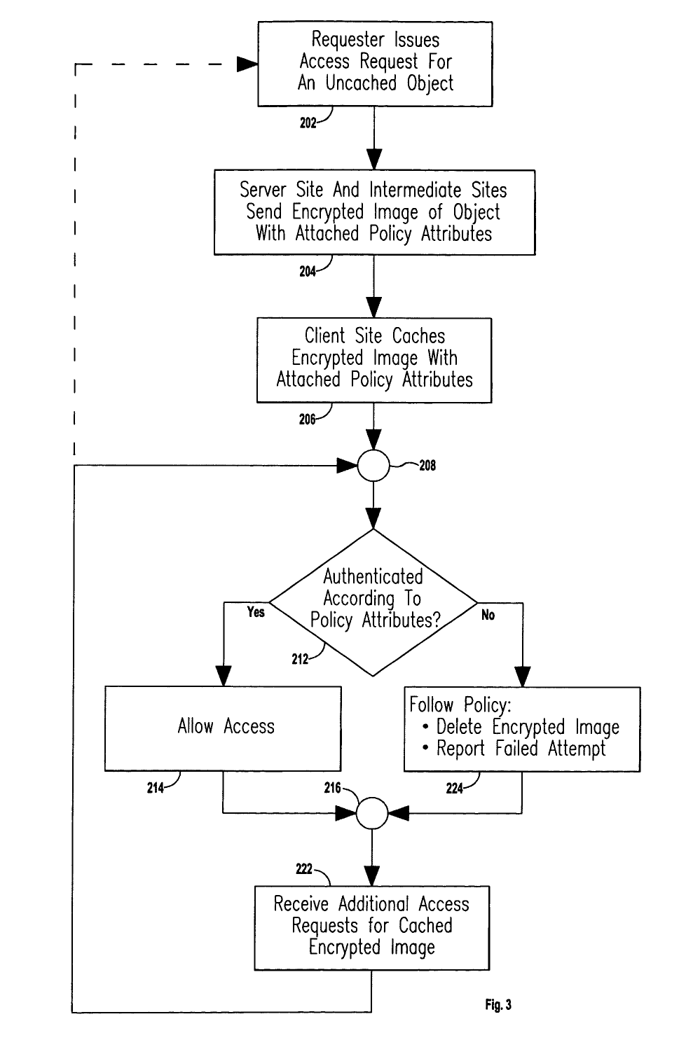

The overall flow chart of FIG. 3 depicts retrieving an encrypted image of an object from a NDC server site 22, caching it at a NDC client site 24, and providing a decrypted image of the object to an authorized requester. As illustrated in FIG. 3, providing an authorized requester with a decrypted image of an uncached object begins in processing block 202 with the requester's access request for the object. In the illustration of FIG. 1, the request by the client workstation 42 for access to an uncached object received by the NDC client site 24 propagates as a DTP request along the data conduit provided by the NDCs 50 that extends from the NDC client terminator site 24 to the NDC server terminator site 22. As described above, the DTP request propagates successively through each of the NDC sites 24, 26B, 26A and 22 in the NDC chain until the DTP request reaches:

1. an intermediate NDC sites 26A or 26B that has a cached image of all the data that is being requested; or

2. the server terminator, i.e., NDC server site 22 in the example depicted in FIG. 1, which stores the source data object either unencrypted or encrypted.

Referring again to FIG. 3, for the request to access an uncached source data object, as indicated in processing block 204 the NDC server site 22 responds by sending an encrypted image of the object. Regardless of which of the NDCs 50 along the data conduit extending from the NDC client terminator site 24 to the NDC server terminator site 22 responds to the DTP request, the response contains an encrypted image of the source data object. Furthermore, as the encrypted image of the source data object proceeds along the data conduit, in many if not most instances commencing at the NDC server site 22, as described in the '968 patent policy attributes may be attached to the encrypted image of the source data object.

This policy attributes associated with the encrypted image of the source data object specify, among other things, how access to the encrypted image is to be administered. Accordingly, the policy attributes associated with the encrypted image of the source data object includes security details such as:

1. how to authenticate requesters seeking to access a decrypted image of the source data object;

2. what to do when the specified authentication routine indicates that the requester is not authorized to access a decrypted image of the source data object; and

3. whether to log every attempt to access a decrypted image of the source data object, or possibly only every unsuccessful attempt to access a decrypted image of the source data object. i.e. an authentication failure.

There exist several possible alternatives for what to do what to do when the specified authentication routine indicates that the requester is not authorized to access a decrypted image of the source data object. For example, the policy attributes may specify that when an authentication failure occurs the NDC client site 24 is to delete the encrypted image from its cache. Similarly, the policy attributes may specify that when authentication failure occurs the NDC client site 24 is to transmit an authentication failure message to the “owner” of the source data object, and/or to a security monitoring center.

As the encrypted image of the source data object proceeds along the data conduit it may traverse one or more of the intermediate NDC sites 26A and 26B. In principle, in accordance with description appearing in the '248 patent application each of the NDCs 50 traversed by the encrypted image of the source data object may be a domain manager for a DDS domain. As the encrypted image of the source data object traverses DDS domain managers, each domain manager may incorporate its own policies into the policy attributes associated with the encrypted image of the source data object. Preferably, any policies incorporated into policy attributes associated with the encrypted image of the source data object by a domain manager cannot weaken or undo the policies already specified in the policy attributes as they were received.

Ultimately, as indicated in processing block 206 the encrypted image of the source data object together with the policy attributes are received by and cached at the NDC client site 24. Upon arrival of the encrypted image of the source data object at the NDC client site 24, the NDC client site 24 references all policies in the policy attributes and complies with them.

Now possessing the policies which are to be applied in providing access to the encrypted image of the source data object, proceeding through junction block 208 in decision block 212 the NDC client site 24 attempts to assess whether the requester is authorized to access a decrypted image of the source data object. Assessing whether the requester is authorized to access a decrypted image of the source data object uses any authentication routine specified in the policies associated with the encrypted image of the source data object. When the policies associated with the encrypted image of the source data object fail to specify an authentication procedure, the NDC client site 24 invokes a default authentication routine.

With the encrypted image of the source data object now cached at the NDC client site 24, when the requester is authorized to access a decrypted image of the source data object the authentication routine or the NDC server site 22 securely provides a decryption key to the NDC client site 24. The decryption key permits the NDC client site 24 in processing block 214 to:

1. decrypt the cached encrypted image of the object thereby obtaining the decrypted image of the object; and

2. provide the decrypted image of the object to the requester.

Having provided the requester with access to the decrypted image of the object, proceeding through junction block 216 the NDC client site 24 in processing block 222 receives additional requests for access to the cached encrypted image of the object.

When it is determined in decision block 212 that the requester is not authorized to access a decrypted image of the source data object, in processing block 224 in accordance with the policy attributes described above the encrypted image of the source data object may be deleted, and/or the failed attempt may be reported. As specified by the policy attributes the failed attempt may be reported to the server site, a security monitoring agency, the object's owner, and/or any other designated entity that can be contacted via any network accessible to the site that has detected the authentication failure.

When the NDC client site 24 having a cached encrypted image of the source data object receives a subsequent request for access thereto in processing block 222, the NDC client site 24 returns to junction block 208 and processes the request for access in the same way as before. If because policy attributes associated with the encrypted image of the source data object has caused it to be deleted from the cache, perhaps in processing block 224 due to a failed access request, then the processing of an additional request for access to the source data object proceeds to processing block 202.

Although the present invention has been described in terms of the presently preferred embodiment, it is to be understood that such disclosure is purely illustrative and is not to be interpreted as limiting. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:

1. not invoke paragraph 6 of 35 U.S.C. § 112 as it exists on the date of filing hereof unless the phrase “means for” appears expressly in the claim's text;

2. omit all elements, steps, or functions not expressly appearing therein unless the element, step or function is expressly described as “essential” or “critical;”

3. not be limited by any other aspect of the present disclosure which does not appear explicitly in the claim's text unless the element, step or function is expressly described as “essential” or “critical;” and

4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's test.

What is claimed is:

1. In a network of digital computers, a method for controlling access by a requester to a decrypted image of an object for which an encrypted image of the object:
a) has been retrieved from a server site included in the network of digital computers; and
b) is stored in a cache of a client site included in the network of digital computers;
the method comprising the steps of:
a) invoking an authentication routine for assessing whether the requester is authorized to access the decrypted image of the object;
b) when the authentication routine determines that the requester is authorized to access the decrypted image of the object, securely providing a decryption key to the client site in the network of digital computers that permits the client site to:
i) decrypt the cached encrypted image of the object thereby obtaining the decrypted image of the object; and
ii) provide the decrypted image of the object to the requester.

2. The method of claim 1 wherein the client site after receiving the decryption key preserves the confidentiality of the decryption key.

3. The method of claim 2 wherein the client site after receiving the decryption key, in addition to preserving the confidentiality of the decryption key, permits using the decryption key only for decrypting the cached encrypted image of the object for providing the decrypted image of the object to authorized requesters.

4. The method of claim 1 wherein when the authentication routine indicates that the requester is not authorized to access the decrypted image of the object, the object is deleted from the cache of the client site in the network of digital computers.

5. The method of claim 4 wherein when the authentication routine indicates that the requester is not authorized to access the decrypted image of the object, an authentication failure message is transmitted to a site selected from a group consisting of the server site, a security monitoring agency, the object's owner, and any other designated entity that can be contacted via any network accessible to the site that has detected the authentication failure.

6. The method of claim 1 wherein when the authentication routine indicates that the requester is not authorized to access the decrypted image of the object, an authentication failure message is transmitted to a site selected from a group consisting of the server site, a security monitoring agency, the object's owner, and any other designated entity that can be contacted via any network accessible to the site that has detected the authentication failure.

7. The method of claim 1 wherein the server site provides the decryption key to the client site.

8. The method of claim 1 wherein the authentication routine provides the decryption key to the client site.
